(19) United States
(12) Patent Application Publication
(10) Pub. No.: US 2024/0017291 A1
(43) Pub. Date: Jan. 18, 2024

(54) 2-Wet Coating Method For Preparing Multilayer Coating Systems

(71) Applicant: BASF COATINGS GMBH, Münster (DE)

(72) Inventors: Kevin Michael TURLEY, Southfield, MI (US); Lisa Jean HARLOW, Southfield, MI (US); Jan WINSBERG, Münster (DE)

(21) Appl. No.: 18/041,962

(22) PCT Filed: Aug. 18, 2021
(86) PCT No.: PCT/EP2021/072974

§ 371 Date: Feb. 16, 2023

(30) Foreign Application Priority Data
Aug. 18, 2020 (EP) 20191501.4

(51) Int. Cl. B05D 7/00; B05D 3/02; B05D 1/36

(52) U.S. Cl. CPC B05D 7/532; B05D 3/0254; B05D 1/36; B05D 2401/21

(57) ABSTRACT

Disclosed herein is a method for preparing a multilayer coating system on a substrate including at least the steps of applying a first coating material composition to a substrate (step (1)), applying a second coating material composition to the first coating film formed in step (1) prior to curing the first coating film and forming a second coating film (step (2)) and jointly curing the first and second coating films (step (3)).

### CROSS-REFERENCE TO RELATED APPLICATIONS

This application is a U.S. National Phase Application of International Patent Application No. PCT/EP2021/072974, filed Aug. 18, 2021, which claims priority to European Patent Application No. 20191501.4, filed Aug. 18, 2020, each of which is hereby incorporated by reference herein.

The present invention relates to a method for preparing a multilayer coating system on a substrate comprising at least the steps of applying a first coating material composition to a substrate (step (1)), applying a second coating material composition to the first coating film formed in step (1) prior to curing the first coating film and forming a second coating film (step (2)) and jointly curing the first and second coating films (step (3)), wherein one of the first and second coating material compositions comprises prior to its use in step (1) or (2) at least one amino resin (AR) as crosslinking agent, and the remaining coating material composition of these two compositions prior to its use in step (1) or (2) is free of any crosslinking agents, but comprises at least one crosslinking catalyst (CLC1), a multilayer coating system on a substrate, which is obtainable by the inventive method and a use of an amino resin (AR) as a migrating crosslinking agent.

### BACKGROUND OF THE INVENTION

In typical automotive coating processes, at least four layers are applied to the metal surface of a suitable substrate: an electrodeposition coat (e-coat), a primer, a basecoat, and a clearcoat. The e-coat and the primer layers are generally applied to the substrate surface and cured. Subsequently, a basecoat formulation is applied with a solvent, and the solvent is flashed off in a high temperature process. After properly conditioning the basecoat, the clearcoat is applied next. Then the coated substrate surface is passed through an oven at temperatures in excess of 140° C. to cure the basecoat and clearcoat.

Although this conventional process is adequate and used commercially worldwide in the automotive industry, there is significant room for improvement. For one, any reduction in energy, materials, or the time required to make these coatings would result in large economic gains due to the large scale of use. In particular, it would be advantageous for vehicle manufacturers to reduce the number of high temperature steps as well as the process time. Additionally, it would be beneficial to reduce the temperature at which these steps are conducted. Further, there is a desire to develop “lightweight” vehicles. A means for greatly reducing the weight of the automobile body is to replace heavier metal parts with lighter weight plastic parts. However, the use of light-weight plastics in the conventional process is an issue because many light-weight plastic substrate materials physically deform at curing temperatures greater than 130° C. Consequently, a reduction in the curing temperatures of the basecoat and the clearcoat would permit the use of plastic and other heat sensitive substrates necessary to reduce the weight of vehicle fleets. Moreover, it would be beneficial to employ single-component (1K) systems that are stable for extended periods of time without decomposing or prematurely curing as is typical for two-component (2K) systems in which one component contains a curable resin/polymer and the other component contains a crosslinking agent for the curable resin. In such 2K systems the reactive species, i.e. the crosslinking agent needs to be isolated until just prior to application.

WO 2018/019685 A1 discloses a low temperature cure composite coating comprising a substrate and two coating layers applied thereon from solventborne coating material compositions. The compositions each comprise an OH-functional resin, a crosslinking agent, and a catalyst. The catalyst present in the first solventborne basecoat composition catalyzes a crosslinking reaction of constituents present in the second solventborne clearcoat composition and the catalyst present in the second composition catalyzes a crosslinking reaction of constituents present in the first composition. Crosslinking only occurs after migration of each of the catalysts into each adjacent layer has taken place. WO 2018/019686 A1 relates to a similar low temperature cure composite coating comprising a substrate and two coating layers applied thereon. However, only one coating layer, namely the clearcoat layer, is applied from a solventborne coating material composition as second composition, whereas the other coating layer, namely the basecoat layer is applied from a waterborne coating material composition as first composition. Similarly, US 2019/031910 A1 also relates to a low temperature cure composite coating comprising a substrate and two coating layers applied thereon. Each of the first and second coating material compositions disclosed in WO 2018/019685 A1, WO 2018/01968 A1 and US 2019/031910 A1 requires both the presence of a crosslinking agent and a catalyst.

WO 2019/020324 A1 discloses a double coating on a substrate comprising a first layer prepared from a polar composition including a non-polar catalyst and a second layer prepared from a non-polar composition including a polar catalyst. The polar and non-polar compositions disclosed in WO 2019/020324 A1 require both the presence of a crosslinking agent and a catalyst.

Thus, there is a need for further and improved methods for providing multilayer coatings on substrates to be used for the automotive industry, which allow for a reduction in energy, materials, and curing time, but nonetheless exhibit good mechanical and optical properties.

### PROBLEM

It has been therefore an object underlying the present invention to provide a further and improved method for providing multilayer coatings on substrates to be used for the automotive industry, which allow in particular for a reduction in materials, and curing time and temperature, but wherein the obtained multilayer coated substrates nonetheless exhibit good mechanical and optical properties.

### SOLUTION

This object has been solved by the subject-matter of the claims of the present application as well as by the preferred embodiments thereof disclosed in this specification, i.e. by the subject matter described herein.

A first subject-matter of the present invention is a method for preparing a multilayer coating system on a substrate comprising at least steps (1), (2), and (3), namely
(1) applying a first coating material composition to an optionally pre-coated substrate and forming an first coating film on the optionally pre-coated substrate,
(2) applying a second coating material composition to the first coating film present on the substrate obtained after step (1) prior to curing the first coating film and forming a second coating film adjacent to the first coating film,
(3) jointly curing the first and second coating films, the cured second coating film being the outermost layer of the formed multilayer coating system,
   wherein the first and second coating material compositions are different from one another, the first coating material composition comprises at least one polymer (P1) having crosslinkable functional groups and the second coating material composition comprises at least one polymer (P2) having crosslinkable functional groups,
   wherein one of the first and second coating material composition further comprises prior to its use in step (1) or (2) at least one amino resin (AR) as crosslinking agent having crosslinkable functional groups, which can be crosslinked with the crosslinkable functional groups of both polymer (P1) and polymer (P2), and the remaining of these two coating material compositions prior to its use in step (1) or (2) is free of any crosslinking agents, but comprises prior to its use in step (1) or (2) at least one crosslinking catalyst (CLC1), which is suitable to catalyze a crosslinking reaction between the functional groups of the amino resin (AR) and the functional groups of both polymer (P1) and polymer (P2).

A further subject-matter of the present invention is a multilayer coating system on a substrate, which is obtainable by the inventive method.

A further subject-matter of the present invention is a use of an amino resin (AR) having crosslinkable functional groups,

which is present in either a first coating material composition or a second coating material composition, both coating material compositions being different from one another, the first coating material composition comprising at least one polymer (P1) having crosslinkable functional groups, which can be crosslinked with the crosslinkable functional groups of the amino resin (AR), and the second coating material composition comprising at least one polymer (P2) having crosslinkable functional groups, which can be also crosslinked with the crosslinkable functional groups of the amino resin (AR), wherein the coating material composition selected from the first and second coating material composition, in which the amino resin (AR) is not present, is free of any crosslinking agents, but comprises at least one crosslinking catalyst (CLC1), which is suitable to catalyze a crosslinking reaction between the functional groups of the amino resin (AR) and the functional groups of both polymer (P1) and polymer (P2), for at least partially migrating from a coating film obtained from the one coating material composition selected from the first and second coating material composition, in which it is present, into a coating film obtained from the remaining coating material composition of these two coating material compositions after having applied the second coating material composition to a coating film obtained from the first coating material composition prior to curing said first coating film to form a second coating film adjacent to the first coating film and for subsequent crosslinking with the crosslinkable functional groups of both polymer (P1) and polymer (P2), preferably catalyzed at least by the crosslinking catalyst (CLC1).

It has been surprisingly found that the inventive method allows for not having to incorporate a crosslinking agent into each of the coating material compositions used and applied in the inventive method. Rather, it is merely necessary to incorporate at least one amino resin (AR) into one of the two coating material compositions used. It has been surprisingly found that said amino resin (AR) is able to partially migrate from the first coating film into the second coating film or vice versa after having applied both coating films via the inventive wet-on-wet method. Likewise, as at least the coating material composition not containing any amino resin (AR) contains at least one crosslinking catalyst (CLC1), said crosslinking catalyst (CLC1) is also able to migrate from the coating film obtained from the coating material composition, into which it had been included, into the other coating film after having applied both coating films via the inventive wet-on-wet method. Thus, the inventive method allows migration of both the amino resin (AR) and the crosslinking catalyst (CLC1) originally contained in separate coating films once both coating films have been applied wet-on-wet.

It has been surprisingly found that the inventive method allows for a curing step, wherein all coating films applied are jointly cured, to be carried out at temperatures below 110° C., in particular below 100° C., for comparably short periods of time such as below 30 or even below 25 minutes. It is surprising that an effective curing of all coating films applied at such low temperatures can be performed, although at least one of the coating films has been applied by making use of a coating material composition not containing any crosslinking agent. It is in particular surprising that sufficient migration in particular of the amino resin (AR) takes place in order to allow for such an effective curing at these temperatures.

It has also been surprisingly found that the inventive method—when the first coating material composition is a primer coating material composition and the second coating material composition is a topcoat coating material composition, in particular wherein said topcoat composition actually corresponds to a basecoat material composition—it is sufficient to perform curing step (3) without the need of further applying a clearcoat coating material composition. This is in particular useful in case the substrate is e.g. a part of the engine compartment of a vehicle, wherein in the OEM process it is preferable not to apply any clearcoat layer on this part. The inventive method, however, allows, e.g. to use a primer coating material composition containing the at least one crosslinking catalyst (CLC1), which is able to migrate from the coating film formed after having performed the wet-on-wet application into the basecoat layer obtained from using a base coating material composition as second coating material composition containing the at least one amino resin (AR), without having to additionally apply a clear coating composition, as said base coating material composition functions as topcoat material composition in this case.

### DETAILED DESCRIPTION OF THE INVENTION

The term “comprising” in the sense of the present invention, in connection for example with the each of the inventively used coating material compositions preferably has the meaning of “consisting of”. With regard to each of the inventively used coating material compositions it is possible—in addition to the mandatory components present therein — for one or more of the further components identified hereinafter and included optionally in each of the inventively used coating material compositions to be included therein. All these components may in each case be present in their preferred embodiments as identified below.

The term “prior to its use or prior to their use” in a particular step of the inventive method in connection with the amino resin (AR) and crosslinking catalyst (CLC1) present in any of the inventively used coating material compositions in the sense of the present invention preferably means that the particular constituent, namely (AR) or (CLC1), is present as a constituent in the respective coating material composition prior to using the respective coating material composition in a particular step of the inventive method and is also (still) present or still present therein, when applying any of these respective coating material compositions in any of the particular steps. However, any of these constituents is able to migrate from a coating film obtained from applying the respective coating material composition to further coating films applied on top and/or already present underneath.

Inventive Method

The inventive method is a method for preparing and providing a multilayer coating system on a substrate comprising at least steps (1), (2), and (3). The method may, however, comprise further additional optional steps such as steps (1a) and (2a).

Step (1) of the Method

In step (1) of the inventive method a first coating material composition is applied to an optionally pre-coated substrate and a first coating film is formed on the optionally pre-coated substrate. The first coating film formed on the optionally pre-coated substrate is at this stage an uncured coating film.

The method of the invention is particularly suitable for the coating of automotive vehicle bodies or parts thereof including respective metallic substrates, but also plastic substrates such as polymeric substrates. Consequently, the preferred substrates are automotive vehicle bodies or parts thereof.

Suitability as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Preferably, thermoplastic polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

The substrate used in accordance with the invention is preferably a substrate pretreated with at least one metal phosphate such as zinc phosphate. A pretreatment of this kind by means of phosphating, which takes place normally after the substrate has been cleaned and before the substrate is electrodeposition-coated, is in particular a pretreatment step that is customary in the automobile industry.

As outlined above the substrate used may be a pre-coated substrate, i.e. a substrate bearing at least one cured coating film. The substrate used in step (1) can be pre-coated with a cured electrodeposition coating layer.

The substrate can, e.g., be provided also with at least one cured primer coating film as at least one additional pre-coat. The term “primer” is known to a person skilled in the art. A primer typically is applied after the substrate has been provided with a cured electrodeposition coating layer. In case a cured primer coating film is also present, the cured electrodeposition coating film is present underneath and preferably adjacent to the cured primer coating film.

Optional step (1a) of the Method

Preferably, the inventive method further comprises a step (1a), which is carried out after step (1) and before step (2). In said step (1a) the first coating film obtained after step (1) is flashed-off before applying the second coating material composition in step (2) preferably for a period of 1 to 20 minutes, more preferably for a period of 1.5 to 15 minutes, in particular for a period of 2 to 10 minutes, most preferably for a period of 3 to 6 minutes. Preferably, step (1a) is performed at a temperature not exceeding 40° C., more preferably at a temperature in the range of from 18 to 30° C.

The term “flashing off” in the sense of the present invention means a drying, wherein at least some of the solvents and/or water are evaporated from the coating film (i.e. from the coating layer being formed), before the next coating material composition is applied and/or a curing is carried out. No curing is performed by the flashing-off

Step (2) of the Method

In step (2) of the inventive method a second coating material composition is applied to the first coating film present on the substrate obtained after step (1) prior to curing the first coating film and a second coating film is formed adjacent to the first coating film. Thus, both the first and the second coating material compositions are applied wet-on-wet.

Optional Step (2a) of the Method

Preferably, the inventive method further comprises a step (2a), which is carried out after step (2) and before step (3). In said step (2a) the second coating film obtained after step (2) is zo flashed-off before performing curing step (3) preferably for a period of 1 to 20 minutes, more preferably for a period of 2 to 15 minutes, in particular for a period of 3 to 12 minutes. Preferably, step (2a) is performed at a temperature not exceeding 40° C., more preferably at a temperature in the range of from 18 to 30° C.

Preferably, both step (1a) and step (2a) are performed. Preferably, the flash-off time used in case of step (2a) exceeds the flash-off time used in case of step (1a).

Step (3) of the Method

In step (3) of the inventive method the first and second coating films are jointly cured, i.e. are cured together simultaneously. The cured second coating film represents the outermost layer of the formed multilayer coating system obtained after step (3).

Each resulting cured coating film represents a coating layer. Thus, after performing step (3) a first and second coating layer are formed on the optionally pre-coated substrate, with the second layer being the outermost layer of the formed multilayer coating system.

Preferably, step (3) is performed at a substrate temperature less than 110° C., preferably less than 105° C. in particular at a substrate temperature in the range of from 80 to 105° C. or 80 to 100° C., for a period of 5 to 45 minutes, preferably for a period of 10 to 35 minutes. The substrate temperature is measured with a thermocouple.

First and Second Coating Material Compositions and First and Second Coating Films Resulting Therefrom

The first and second coating material compositions used in steps (1) and (2) are different from one another. The first coating material composition comprises at least one polymer (P1) having crosslinkable functional groups and the second coating material composition comprises at least one polymer (P2) having crosslinkable functional groups.

One, i.e. precisely one, of the first and second coating material compositions comprises prior to its use in step (1) or (2) at least one amino resin (AR) as crosslinking agent, and the remaining of these two coating material compositions prior to its use in step (1) or (2) is free of any crosslinking agents, but comprises prior to its use in step (1) or (2) at least one crosslinking catalyst (CLC1). The at least one amino resin (AR) has crosslinkable functional groups, which can be crosslinked with the crosslinkable functional groups of both polymer (P1) and polymer (P2). Thus, it is clear that the amino resin (AR) is different from each of the polymers (P1) and (P2). The at least one crosslinking catalyst (CLC1) is suitable to catalyze a crosslinking reaction between the functional groups of the amino resin (AR) and the functional groups of both polymer (P1) and polymer (P2).

In the sense of the present invention the term “free of any crosslinking agents” preferably means that no crosslinking agents are present in the respective coating material composition prior to its use in the inventive method. This means that such crosslinking agents are not added on purpose to any of the inventively used coating material compositions. It may, however, not be ruled out that any remaining residues of such crosslinking agent used for preparing e.g. some components present in the compositions are (still) present therein. Thus, preferably, the amounts of any crosslinking agent present in the coating material composition, which is “free of any crosslinking agents” is less than 1.0 wt.-% or less than wt.-%, most preferably less than 0.1 wt.-% or less than 0.05 wt.-% or less than 0.01 wt.-%, in each case based on the total weight of the coating material composition.

Preferably, the coating material composition selected from the first and second coating material compositions, which comprises prior to its use in step (1) or (2) the at least one amino resin (AR) as crosslinking agent, does not comprise prior to its use in step (1) or (2) any crosslinking catalyst at all or comprises prior to its use in step (1) or (2) at least one crosslinking catalyst (CLC2) being identical or different to the at least one crosslinking catalyst (CLC1) in an amount, based on the total weight of the coating material composition, which is lower than the amount of the least one crosslinking catalyst (CLC1) present in the remaining of the said two coating material compositions, which is prior to its use in step (1) or (2) free of any crosslinking agents, based on the total weight of said coating material composition.

In case at least one crosslinking catalyst (CLC2) is present in the coating material composition, which comprises the at least one amino resin (AR), the relative weight ratio of the at least one crosslinking catalyst (CLC1) present in the coating material composition selected from the first and second coating material compositions, which prior to its use in step (1) or (2) is free of any crosslinking agents, to said at least one crosslinking catalyst (CLC2), is at least 5:1, more preferably at least 4:1, still more preferably at least 3:1, based in each case on the total weight of each of the coating material compositions.

Preferably, the first coating material composition comprises prior to its use in step (1) the at least one amino resin (AR) as crosslinking agent and optionally at least one crosslinking catalyst (CLC2) being identical or different to the at least one crosslinking catalyst (CLC1) and the second coating material composition comprises prior to its use in step (2) the at least one crosslinking catalyst (CLC1) or in that the second coating material composition comprises prior to its use in step (2) the at least one amino resin (AR) as crosslinking agent and optionally at least one crosslinking catalyst (CLC2) being identical or different to the at least one crosslinking catalyst (CLC1) and the first coating material composition comprises prior to its use in step (1) the at least one crosslinking catalyst (CLC1).

Preferably, the first coating material composition is a 1K (one-component) coating material composition. Preferably, the second coating material composition is a 1K (one-component) coating material composition.

Preferably, the first coating material composition is a solventborne, i.e. an organic solvent(s) based, or a waterborne, i.e. an aqueous, coating material composition and the second coating material composition is a solventborne or waterborne, preferably solventborne, coating material composition.

The term “aqueous” or “waterborne” in connection with any of the inventively used coating material compositions is understood preferably for the purposes of the present invention to mean that water, as solvent and/or as diluent, is present as the main constituent of all solvents and/or diluents present in each if the inventively used coating material compositions, preferably in an amount of at least 35 wt.-%, based on the total weight of the electrodeposition coating composition of the invention. Organic solvents may be present additionally in smaller proportions, preferably in an amount of <20 wt.-%.

Each of the inventively used coating material compositions preferably includes - in case the composition is waterborne - a water fraction of at least 40 wt.-%, more preferably of at least 45 wt.-%, very preferably of at least 50 wt.-%, more particularly of at least 55 wt.-%, based in each case on the total weight of the coating material composition.

Each of the inventively used coating material compositions preferably includes—in case the composition is waterborne—a fraction of organic solvents that is <20 wt.-%, more preferably in a range of from 0 to <20 wt.-%, very preferably in a range of from 0.5 to 20 wt.-% or to 17.5 wt.-% or to 15 wt.-% or to 10 wt.-%, based in each case on the total weight of the coating material composition. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof.

The term “solventborne” in connection with any of the inventively used coating material compositions is understood preferably for the purposes of the present invention to mean that organic solvent(s), as solvent and/or as diluent, is present as the main constituent of all solvents and/or diluents present in each if the inventively used coating material compositions, preferably in an amount of at least 35 wt.-%, based on the total weight of the electrodeposition coating composition of the invention. Water may be present additionally in smaller proportions, preferably in an amount of <20 wt.-%.

Each of the inventively used coating material compositions preferably includes—in case the composition is solventborne—an organic solvent(s) fraction of at least 40 wt.-%, more preferably of at least 45 wt.-%, very preferably of at least 50 wt.-%, more particularly of at least 55 wt.-%, based in each case on the total weight of the coating material composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof.

Each of the inventively used coating material compositions preferably includes—in case the composition is solventborne—a fraction of water that is <20 wt.-%, more preferably in a range of from 0 to <20 wt.-%, very preferably in a range of from 0.5 to 20 wt.-% or to 17.5 wt.-% or to 15 wt.-% or to 10 wt.-%, based in each case on the total weight of the coating material composition.

The solids content of each of the inventively used coating material compositions is independently of one another preferably in a range of from 5 to 45 wt.-%, more preferably of from 5 to 40 wt.-%, very preferably of from 7.5 to 40 wt.-%, more particularly of from 7.5 to 35 wt.-%, most preferably of from 10 to 35 wt.-% or of from 15 to 30 wt.-%, based in each case on the total weight of the coating material composition. The solids content, in other words the nonvolatile fraction, is determined in accordance with the method described hereinafter.

Preferably, the first coating material composition is a basecoat material coating composition and the second coating material composition is a clearcoat coating material composition or the first coating material composition is a primer material coating composition and the second coating material composition is a topcoat coating material composition. In the first case, the basecoat material coating composition is preferably waterborne or solventborne and the clearcoat coating composition is preferably solventborne. In the second case, the primer material coating composition is preferably waterborne or solventborne, in particular solventborne, and the topcoat coating composition is preferably solventborne or waterborne, in particular solventborne.

Each of the inventively used coating material compositions can be used both as OEM coating composition and for refinish applications, preferably for OEM applications.

The term “base coat”, “basecoat” or “base coating” is known to a person skilled in the art and, for example, defined in Rompp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition. This is generally applied to a metal or plastic substrate, and in the case of metal substrates on a primer layer applied over an electrodeposition coating layer coated onto the metal substrate, or to already existing coatings in case of refinish applications, which can also serve as substrates. In order to protect a basecoat film in particular against environmental influences, at least one additional clearcoat film is applied to it. The term “clear coat”, “clearcoat” or “clear coating” is also known to a person skilled in the art and represent a transparent outermost layer of a multilayer coating structure applied to a substrate.

The proportions and amounts in wt.-% (% by weight) of all components present in each of the inventively used coating material compositions add up in each case to 100 wt.-%, based on the total weight of each the coating compositions.

Polymers (P1) and (P2)

The first coating material composition comprises at least one polymer (P1) having crosslinkable functional groups. The second coating material composition comprises at least one polymer (P2) having crosslinkable functional groups.

The polymers (P1) and (P2) can be identical or can be different from one another. Each of these polymers is different from the amino resin (AR).

The polymers (P1) and (P2) function as film-forming binders. For the purposes of the present invention, the term “binder” is understood in accordance with DIN EN ISO 4618 (German version, date: March 2007) to be the non-volatile constituent of a coating material composition, which is responsible for the film formation. Pigments and/or fillers contained therein are thus not subsumed under the term “binder”. Preferably, the at least one polymer is the main binder of the respective coating material composition. As the main binder in the sense of the present invention, a binder component is preferably referred to, when there is no other binder component in the coating material composition, which is present in a higher proportion based on the total weight of the coating material composition.

The term “polymer” is known to the person skilled in the art and, for the purposes of the present invention, encompasses polyadducts and polymerizates as well as polycondensates. The term “polymer” includes both homopolymers and copolymers.

Each of the polymers (P1) and (P2) has crosslinkable functional groups, which can be crosslinked with the crosslinkable functional groups of the amino resin (AR), i.e. which enable a crosslinking reaction with the crosslinkable functional groups of the amino resin (AR). The crosslinkable groups of the polymers (P1) and (P2) may be identical or different from one another. Any common crosslinkable functional group known to those skilled in the art can be present. The crosslinkable functional groups of each of the polymers (P1) and (P2) are independently of one another selected from the group consisting of primary amino groups, secondary amino groups, hydroxyl groups, thiol groups, carboxyl groups and carbamate groups. Preferably, each of the polymers (P1) and (P2) has functional hydroxyl groups (OH-groups) and/or carbamate groups, in particular hydroxyl groups.

Each of polymers (P1) and (P2) is preferably independently of one another selected from the group consisting of polyurethanes, polyureas, polyesters, polyamides, polyethers, poly(meth)acrylates and/or copolymers of the structural units of said polymers, in particular polyurethane-poly(meth)acrylates and/or polyurethane polyureas, and hybrid polymers thereof. In particular, each of polymers (P1) and (P2) is preferably independently of one another selected from the group consisting of polyurethanes, polyesters, poly(meth)acrylates and/or copolymers of the structural units of said polymers. The term “(meth) acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyesters are described, for example, in DE 4009858 A1 in column 6, line 53 to column 7, line 61 and column 10, line 24 to column 13, line 3 or WO 2014/033135 A2, page 2, line 24 to page 7, line 10 and page 28, line 13 to page 29, line 13 described. Likewise preferred polyesters are polyesters having a dendritic structure, as described, for example, in WO 2008/148555 A1. These can be used not only in clearcoats, but also in particular aqueous basecoats.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred poly(meth) acrylates are those which can be prepared by multistage free-radical emulsion polymerization of olefinically unsaturated monomers in water and/or organic solvents. For example, seed-core-shell polymers (SCS polymers) are particularly preferred. Such polymers or aqueous dispersions containing such polymers are known, for example, from WO 2016/116299 A1. Particularly preferred seed-core-shell polymers are polymers, preferably those having an average particle size of 100 to 500 nm, which can be prepared by successive free-radical emulsion polymerization of three preferably different monomer mixtures (A1), (B1) and (C1) of olefinic unsaturated monomers in water, wherein the mixture (A1) contains at least 50 wt.-% of monomers having a solubility in water of less than 0.5 g/l at 25° C. and a polymer which is prepared from the mixture (A1), has a glass transition temperature of 10 to 65° C., the mixture (B1) contains at least one polyunsaturated monomer, and a polymer prepared from the mixture (B1) has a glass transition temperature of −35 to 15° C., and a polymer which is prepared from the mixture (C1) has a glass transition temperature of −50 to 15° C., and wherein i. first the mixture (A1) is polymerized, ii. then the mixture (B1) in the presence of the polymer formed under i. is polymerized, and iii. then the mixture (C1) in the presence of the poylmer formed under ii. is polymerized. All three mixtures are preferably different from one another.

Preferred polyurethane-polyurea copolymers are polyurethane-polyurea particles, preferably those having an average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

In particular, each of polymers (P1) and (P2) is hydroxyl-functional and more preferably has an OH number in the range of 15 to 200 mg KOH/g, more preferably from 20 to 150 mg KOH/g. Most preferred are corresponding hydroxyl-functional polyurethane-poly(meth)acrylate copolymers, hydroxyl-functional polyesters, hydroxyl-poly(meth)acrylate copolymers and/or hydroxyl-functional polyurethane-polyurea copolymers.

Preferably, the at least one polymer (P1) is present in the first coating material composition in an amount in a range of from 10 to 50 wt.-%, more preferably of from 12 to 45 wt.-%, based in on the total weight of the coating material composition.

Preferably, the at least one polymer (P2) is present in the second coating material composition in an amount in a range of from 10 to 50 wt.-%, more preferably of from 12 to wt.-%, based in on the total weight of the coating material composition.

Amino Resin (AR)

Preferably, the at least one amino resin (AR) used as crosslinking agent present in either the first or the second coating material composition is an aminoplast resin, more preferably a melamine resin, even more preferably a melamine formaldehyde resin, in particular a hexamethoxymethyl melamine formaldehyde resin. Aminoplast resins in general are based on the condensation products of formaldehyde, with an amino- and/or amido-group carrying substance, such as melamine, urea, and/or benzoguanamine.

The at least one amino resin (AR) contains crosslinkable functional groups, which are reactive with the crosslinkable functional groups of both polymers (P1) and (P2), such as OH-groups, when catalyzed preferably at least by the at least one crosslinking catalyst (CLC1).

Examples of suitable aldehydes for preparing suitable melamine formaldehyde resins include those resulting in a C₁ to C₈ group bonded to a nitrogen atom pending from the triazene ring of the melamine, which C₁ to C₈ alcohol group takes the place of a nitrogen-bonded hydrogen atom. Specific examples of suitable aldehydes include, but are not limited to, formaldehyde, acetaldehyde, propaldehyde, butyraldehyde, and combinations thereof. Formaldehyde is particularly preferred. Preferably, the at least one melamine resin used as amino resin (AR) is a formaldehyde resin, more preferably a monomeric melamine formaldehyde resin, even more preferably a hexamethoxyalkyl melamine formaldehyde resin, in particular a hexamethoxyalkyl melamine formaldehyde resin selected from the group consisting of hexamethoxymethyl melamine formaldehyde resins, hexamethoxybutyl melamine formaldehyde resins, hexamethoxy(methyl and butyl) melamine formaldehyde resins, and mixtures thereof.

The aldehyde and the melamine are typically reacted at a stoichiometric ratio of aldehyde to melamine of from 5.4:1 to 6:1, preferably from 5.7:1 to 6:1, more preferably from 5.9:1 to 6:1. Stated differently, the reactive sites in the melamine, i.e., the imino groups, can be either partially or completed reacted as a result of reaction of the aldehyde and the melamine. Theoretically, a ratio of aldehyde to melamine of 5.4:1 should result in a content of alkylol groups in the resulting product, after reaction of the aldehyde and the melamine but prior to any further reaction such as with an alcohol in a subsequent etherification, of about 90%, based on the total number of reactive sites present in the melamine prior to reaction. Likewise, a ratio of aldehyde to melamine of 5.7:1 should result in a content of alkylol groups of about 95%, a ratio of aldehyde to melamine of 5.9:1 should result in a content of alkylol groups of about 99%, and a ratio of aldehyde to melamine of 6:1 should result in a content of alkylol groups of about 100%, all prior to any further reaction such as with an alcohol and all based on the total number of reactive sites present in the melamine prior to reaction. The reactive sites from the melamine that are unreacted after reaction of the aldehyde and the melamine remain as imino groups in the resulting product.

Preferably, melamine resin used as amino resin (AR) has a content of imino groups of less than or equal to 10% (corresponding to a ratio of aldehyde to melamine of about 5.4:1), more preferably of less than about 5% (corresponding to a ratio of aldehyde to melamine of about still more preferably of less than about 3%, even more preferably of less than about 1% (corresponding to a ratio of aldehyde to melamine of about 5.9:1), based in each case on the total number of reactive sites present in the melamine prior to reaction. The remainder of the groups in the melamine resin, if any, preferably are alkoxyalkyl groups.

The melamine resin used as amino resin (AR) preferably contains alkylol groups, more preferably methylol and/or other alkylol groups such as butylol groups. Preferred butylol groups are n-butyol groups. Methylol groups or mixtures of methylol and butylol groups are also possible. Most preferred are methylol groups.

At least some of the alkylol groups present in the melamine resin used as amino resin (AR) may be alkylated through further reaction with at least one alcohol to produce nitrogen-bonded alkoxyalkyl groups. In particular, the hydroxyl groups in the nitrogen-bonded alkylol groups may be reacted with the alcohol through an etherification reaction to produce nitrogen-bonded alkoxyalkyl groups. The alkoxyalkyl groups are available for a crosslinking reaction with the crosslinkable functional groups of both polymers (P1) and (P2), such as OH— and/or carbamate groups. The remaining imino groups present in the melamine resin used as amino resin (AR) after the aldehyde/melamine reaction are unreactive with the alcohol used for alkylation. Some of the remaining imino groups may react with the hydroxyl group in a nitrogen-bonded alkylol group from another melamine to form a bridging unit. However, most of the remaining imino groups remain unreacted.

As outlined above the alkylol groups of the melamine resin used as amino resin (AR) may be partially alkylated. By “partially alkylated”, it is meant that a sufficiently low amount of alcohol is reacted with the melamine resin to leave some of the alkylol groups in the melamine resin under reaction conditions that should result in incomplete alkylation of the alkylol groups. When the melamine resin is partially alkylated, it is typically alkylated with alcohol in amounts sufficient to leave alkylol groups present in the aminoplast in an amount of at least about 7%, more preferably of from about 10% to about 50%, even more preferably of from about 15% to about 40%, in each case based on the total number of reactive sites present in the melamine prior to reaction. Typically, the melamine resin is partially alkylated to obtain from about 40 to about 93% of alkoxyalkyl groups, more preferably of from about 50% to about 90%, even more preferably of from about 60% to about 75%, in each case based on the total number of reactive sites present in the melamine prior to reaction. Thus, when partially alkylated, the melamine resin is typically alkylated with at least one alcohol in a stoichiometric amount of hydroxyl groups in the alcohol to alkylol groups in the melamine resin of from about 0.5:1.0 to about 0.93:1.0, more preferably o from about to about 0.9:1.0, even more preferably of from about 0.6:1 to about 0.85:1.0.

Preferably, at least a portion, more preferably only a portion, of the alkylol groups such as methylol groups of the melamine resin is etherified by reaction with at least one alcohol. Any monohydric alcohol can be employed for this purpose, including methanol, ethanol, n-propanol, iso-propanol, n-butanol, sec-butanol, t-butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. In particular, melamine resin used as amino resin (AR) is partially with methanol and/or butanol, most preferred with methanol and/or n-butanol.

Preferably melamine resin used as amino resin (AR) is a melamine aldehyde resin, in particular a melamine formaldehyde resin, bearing alkylol groups, preferably methylol and/or butylol groups, as crosslinkable functional groups, preferably in an amount of at least 90%, based on the total number of reactive sites present in the melamine prior to reaction with the aldehyde, and preferably has a content of imino groups of equal to or less than 10%, more preferably of equal to or less than 5%, still more preferably of equal to or less than 3%, in particular of equal to or less than 1%, in each case based on the total number of reactive sites present in the melamine prior to reaction with the aldehyde.

Melamine formaldehyde resins as melamine resins including at least one methylol group (—CH₂OH) and/or at least one alkoxymethyl group of general formula —CH₂OR¹, where R¹ is an alkyl chain having of from 1 to 20 carbon atoms, preferably of from 1 to 6 carbon atoms, more preferably from 1 to 4 carbon atoms, and combinations thereof, are particularly preferred. Most preferred are hexamethoxymethyl melamine (HMMM) and/or hexamethoxybutyl melamine (HMBM), with (HMMM) being in particular preferred. Melamine resins comprising with a combination of methoxybutyl and methoxymethyl groups are also suitable as melamine resins.

The alkylol and alkoxyalkyl groups of the melamine resin (e.g., the CH₂OCH₃ ether groups of HMMM) are particularly reactive with e.g., OH-groups and/or carbamate groups of a polymers (P1) and (P2)) such as an OH-functional and/or carbamate-functional polymers, in particular when catalyzed by the at least one crosslinking catalyst (CLC1) such as a strong acid catalyst such as an unblocked sulfonic acid used as crosslinking catalyst (CLC1).

Preferably, the at least one amino resin (AR) used as crosslinking agent has a maximum number average molecular weight of 1500 g/mol. Preferably, the at least one amino resin (AR) used as crosslinking agent has a number average molecular weight in the range of from 200 to 1500 g/mol, more preferably of from 250 to 1000 g/mol, in particular of from 300 to 700 g/mol. The number average molecular weight is determined according to the method disclosed in the ‘method’ section.

Preferably, the at least one amino resin (AR) is present in the one of the first and second coating material composition in an amount in a range of from 10 to 40 wt.-%, more preferably of from 12 to 35 wt.-%, based on the total weight of the coating material composition.

Crosslinking Catalysts (CLC1) and (CLC2)

Preferably, the at least one crosslinking catalyst (CLC1) is present in the one of the first and second coating material composition in an amount in the range of from 5 to 40 wt.-%, more preferably of from 7.5 to 35 wt.-%, based on the total solids content of the coating material composition.

The crosslinking catalyst (CLC1) and (CLC2) can be identical or can be different from one another.

Preferably, the at least one crosslinking catalyst (CLC1) is sulfonic acid such as an unblocked sulfonic acid. Preferably also the at least one crosslinking catalyst (CLC2)—if present—is sulfonic acid such as an unblocked sulfonic acid.

Crosslinking catalyst (CLC1)—and preferably also crosslinking catalyst (CLC2)—is suitable to catalyze a crosslinking reaction between the functional groups of the amino resin (AR) such as the alkyol and alkoxymethyl groups and the functional groups of both polymer (P1) and polymer (P2) such as the OH-groups of these polymers

Examples of unblocked sulfonic acids are para-toluenesulfonic acid (pTSA), methanesulfonic acid (MSA), dodecylbenzene sulfonic acid (DDBSA), dinonylnaphthalene disulfonic acid (DNNDSA), and mixtures thereof. DDBSA is in particular preferred, both as crosslinking catalyst (CLC1) and as crosslinking catalyst (CLC2).

If the least one crosslinking catalyst (CLC2) is present in one of the first and second coating material compositions, which additionally contains the at least one amino resin (AR), it is present in an amount in the range of from 1 to 10 wt.-%, more preferably of from 1.5 to 5 wt.-%, based in each case on the total solids content of the respective coating material composition.

Further Optional Components of the Coating Material Compositions

At least the first coating material composition preferably comprises at least one pigment and/or filler. Preferably, only the first coating material composition preferably comprises at least one pigment and/or filler. Preferably, the second coating material composition is free of any pigments.

The term “pigment” is known to the skilled person, from DIN 55943 (date: October 2001), for example. A “pigment” in the sense of the present invention refers preferably to a component in powder or flake form which is substantially, preferably entirely, insoluble in the medium surrounding them, such as in one of the inventively used coating material compositions, for example. Pigments are preferably colorants and/or substances which can be used as pigment on account of their magnetic, electrical and/or electromagnetic properties. Pigments differ from “fillers” preferably in their refractive index, which for pigments is ≥1.7. The term “filler” is known to the skilled person, from DIN 55943 (date: October 2001), for example. “Fillers” for the purposes of the present invention preferably are components, which are substantially, preferably entirely, insoluble in the application medium, such as in one of the inventively used coating material compositions, for example, and which are used in particular for increasing the volume. “Fillers” in the sense of the present invention preferably differ from “pigments” in their refractive index, which for fillers is <1.7.

Any customary filler known to the skilled person may be used. Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide, or organic fillers such as textile fibers, cellulose fibers, polyethylene fibers or polymer powders; for further details, reference is made to Rompp Lexikon Lacke and Druckfarben, Georg Thieme Verlag, 1998, pages 250 ff., “Fillers”.

Any customary pigment known to the skilled person may be used. Examples of suitable pigments for are inorganic and organic coloring pigments. Examples of suitable inorganic coloring pigments are white pigments such as zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Further inorganic coloring pigments are silicon dioxide, aluminum oxide, aluminum oxide hydrate, especially boehmit, titanium dioxide, zirconium oxide, cerium oxide, and mixtures thereof. Examples of suitable organic coloring pigments are monoapigments, disapigments, anthraquinone pigments, benzimidazole pigments, quinoacridone pigments, quinophthalone pigments, diketopyrrolopyrrol pigments, dioxazine pigments, indanthrone pigments, isoindoline pigments, isoindolinone pigments, azomethine pigments, thioindigo pigments metal complex pigments, perinone pigments, perylene pigments, phthalocyanine pigments or aniline black.

If one or more pigments and/or fillers are present in any of the coating material compositions, the proportion thereof in the coating material composition is preferably in the range from 1.0 to 40.0% by weight, preferably 2.0 to 35.0% by weight, particularly preferably 5.0 to 30.0% by weight, in each case based on the total weight of the coating material composition.

Each of the inventively used coating material compositions may contain one or more commonly used additives depending on the desired application. For example, each coating material composition may comprise at least one additive selected from the group consisting of reactive diluents, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, biocides and/or matting agents. They can be used in the known and customary proportions. Preferably, their content, based on the total weight of the coating material composition is 0.01 to 20.0 wt.-%, more preferably 0.05 to 15.0 wt.-20%, particularly preferably 0.1 to 10.0% By weight, most preferably from 0.1 to 7.5% by weight, especially from 0.1 to 5.0% by weight and most preferably from 0.1 to 2.5% by weight.

Each of the inventively used coating material compositions may contain may optionally contain at least one thickener. Examples of such thickeners are inorganic thickeners, for example metal silicates such as sheet silicates, and organic thickeners, for example poly(meth)acrylic acid thickeners and/or (meth)acrylic acid (meth)acrylate copolymer thickeners, polyurethane thickeners and polymeric waxes. Such organic thickeners are encompassed by the polymers (P1) and (P2) used as binder. The metal silicate is preferably selected from the group of smectites. The smectites are particularly preferably selected from the group of montmorillonites and hectorites. In particular, the montmorillonites and hectorites are selected from the group consisting of aluminum-magnesium silicates and sodium-magnesium and sodium-magnesium fluorine-lithium phyllosilicates. These inorganic phyllosilicates are marketed, for example, under the trademark Laponite®.

Thickeners based on poly(meth) acrylic acid and (meth) acrylic acid (meth) acrylate copolymer thickeners are optionally crosslinked and or neutralized with a suitable base. Examples of such thickening agents are “Alkali Swellable Emulsions” (ASE), and hydrophobically modified variants thereof, the “Hydrophically Modified Alkali Swellable Emulsions” (HASE). Preferably, these thickeners are anionic. Corresponding products such as Rheovis® AS 1130 are commercially available. Polyurethane based thickeners (e.g., polyurethane associative thickeners) are optionally crosslinked and/or neutralized with a suitable base. Corresponding products such as Rheovis® PU 1250 are commercially available. Examples of suitable polymeric waxes are optionally modified polymeric waxes based on ethylene-vinyl acetate copolymers. A corresponding product is commercially available, for example, under the name Aquatix® 8421.

If at least one thickener is present in any of the coating material compositions it is preferably present in an amount of at most 10% by weight, more preferably at most 7.5% by weight, most preferably at most 5% by weight, especially at most 3% by weight. %, most preferably not more than 2% by weight, based in each case on the total weight of the coating material composition. The minimum amount of thickener is preferably in each case 0.1% by weight, based on the total weight of the coating material composition.

The preparation of each of the coating material compositions can be carried out using customary and known preparation and mixing methods and mixing units, or using conventional dissolvers and/or stirrers.

Inventive Multilayer Coating System

A further subject-matter of the present invention is a multilayer coating system on a substrate, which is obtainable by the inventive method.

All preferred embodiments described hereinabove in connection with the inventive method are also preferred embodiments with regard to the aforementioned inventive multilayer coating system on a substrate.

Inventive Use

A further subject-matter of the present invention is a use of an amino resin (AR) having crosslinkable functional groups, which is present in either a first coating material composition or a second coating material composition, both coating material compositions being different from one another, the first coating material composition comprising at least one polymer (P1) having crosslinkable functional groups, which can be crosslinked with the crosslinkable functional groups of the amino resin (AR), and the second coating material composition comprising at least one polymer (P2) having crosslinkable functional groups, which can be also crosslinked with the crosslinkable functional groups of the amino resin (AR), wherein the coating material composition selected from the first and second coating material composition, in which the amino resin (AR) is not present, is free of any crosslinking agents, but comprises at least one crosslinking catalyst (CLC1), which is suitable to catalyze a crosslinking reaction between the functional groups of the amino resin (AR) and the functional groups of both polymer (P1) and polymer (P2),

for at least partially migrating from a coating film obtained from the one coating material composition selected from the first and second coating material composition, in which it is present, into a coating film obtained from the remaining coating material composition of these two coating material compositions after having applied the second coating material composition to a coating film obtained from the first coating material composition prior to curing said first coating film to form a second coating film adjacent to the first coating film and for subsequent crosslinking with the crosslinkable functional groups of both polymer (P1) and polymer (P2), preferably catalyzed at least by the crosslinking catalyst (CLC1).

All preferred embodiments described hereinabove in connection with the inventive method and the inventive multilayer coating system on a substrate are also preferred embodiments with regard to the aforementioned inventive use.

METHODS

1. Non-Volatile Fraction

The nonvolatile fraction (the solids or solids content) is determined in accordance with DIN EN ISO 3251 (date: June 2008). This involves weighing out 1 g of sample into an aluminum dish which has been dried beforehand and drying the dish with sample in a drying cabinet at 130° C. for 60 minutes, cooling it in a desiccator, and then reweighing. The residue, relative to the total amount of sample employed, corresponds to the nonvolatile fraction.

2. Number Average Molecular Weight (Mₙ)

To determine average polymer molecular weights (M_{w}, Mₙ and Mₚ) by gel permeation chromatography (GPC), fully dissolved polymer samples are fractionated on a porous column stationary phase. Tetrahydrofuran (THF) is used as the eluent solvent. The stationary phase is a combination of Waters Styragel HR 5, HR 4, HR 3, and HR 2 columns. Five milligrams of a sample are added to 1.5 mL of eluent solvent and filtered through a 0.5 μm filter. After filtering, 100 μl of the polymer sample solution is injected into the column at a flow rate of 1.0 ml/min. Separation takes place according to the size of the polymer coils which form in the eluent solvent. The molecular weight distribution, the number average molecular weight Mₙ, weight average molecular weight M_{w}, and molecular weight of the highest peak Mₚ of the polymer samples were calculated with the aid of a chromatography software utilizing a calibration curve generated with a polymer standard validation kit including a series of unbranched-polystyrene standards of varied molecular weights, which is available from Polymer Standards Service. The polydispersity index (PDI) is determined according to the formula M_{w}/Mₙ.

3. MEK Rub Test

The MEK rub test is performed according to ASTM D5402.

4. Tukon Hardness

To evaluate the Tukon microhardness of a coated substrate a Wolpert Wilson Tukon 2100 device was utilized. A coated substrate is placed upon the stage of the instrument below the Tukon indenter. The indenter uses a pyramid-shaped diamond tip which applies a 25 g load to the surface of the coated substrate for 18±0.5 seconds. The instrument also has a microscope with a filar micrometer eyepiece. After the indentation is complete, the microscope is used to measure the length of the impression. The instrument calculates the Knoop hardness number (KHN) from the following equation:

$$KHN = \frac{0.025}{{L}^{( 2 ) *} {C}_{p}}$$

Where:
0.025=load applied, kg, to the indenter
L=length of long diagonal of indentation, mm, and
Cₚ=indenter constant=7.028×10⁻²

5. Adhesion (Initial and After 10-Day Water Soaking)

Adhesion is measured according to ASTM D3359. The water soaking conditions were performed according to ASTM D870 (Standard Practice for Testing Water Resistance of Coatings Using Water Immersion).

6. Appearance

Cured panels are assessed visually after 10-day water soak exposure for any coating defects. The panels are compared to an unexposed control and any visual differences between the two conditions are noted (i.e. whitening or other color change, blistering, gloss, DOI, or surface smoothness/roughness).

7. MVSS (Initial and After 10-Day Water Soaking)

MVSS is measured according to SAE J1720—Quick Knife Adhesion (QKA) Test for Glass Bonding Systems. The water soaking conditions were performed according to ASTM D870 (Standard Practice for Testing Water Resistance of Coatings Using Water Immersion).

8. Freezer Gravel Testing

Freezer gravel testing is measured according to SAE J400—Test for Chip Resistance of Surface Coatings.

9. Layer Thickness

The dry layer thickness is determined according to ASTM D4138—Standard Practices for Measurement of Dry Film Thickness of Protective Coating Systems by Destructive, Cross-Sectioning Means.

### EXAMPLES

The following examples further illustrate the invention but are not to be construed as limiting its scope.

1. Basecoats Used as First Coating Material Composition 1.1 Solventborne Basecoat Composition BCI

Basecoat composition BC1 has been prepared by mixing the constituents listed in Table 1.1 in this order. BC1 does not contain any crosslinking agent, in particular no amino resin, but contains a crosslinking catalyst (Naxcat® 1270). BC1 has a total solids content of 54.3 wt.-%, based on its total weight.

TABLE 1.1
Black basecoat BC1

| Constituent | Amount [wt.-%] |
|---|---|
| Emulsion microgel | 21.1 |
| N-Methylpyrrolidone | 0.68 |
| Butyl acetate | 1.52 |
| Pentyl propionate | 0.39 |
| Polyester resin (star-shaped) | 20.59 |
| Pentyl propionate | 0.86 |
| Polybutylacrylate | 0.04 |
| Tinuvin ® 384-2 | 0.57 |
| Aerosil ® R-972 dispersion | 3.80 |
| Black pigment paste | 12.25 |
| (containing Monarch ® 1300) | |
| Acrylic resin 1 | 16.72 |
| Cellulose acetate butyrate | 2.86 |
| (20 wt.-% solution) | |
| Naxcat ® 1270 | 15.22 |
| Pentyl propionate | 3.40 |
| Σ | 100.00 |

Naxcat® 1270 is a commercially available sulfonic acid crosslinking catalyst (dodecyl benzene sulfonic acid (DDBSA) in isopropyl alcohol). Naxcat® 1270 is present in BC1 in an amount of 25.46 wt.-%, based on the total solids content of BC1.

Acrylic resin 1 is an c-caprolactone-modified acrylic resin available from BASF Corp. having an OH number of 73 mg KOH/g and a weight average molecular weight of 11100 g/mol. The resin is used in form of dispersion having a solid content of 75 wt.-%.

The polyester resin (star-shaped) is branched aliphatic star-shaped polyester resin available from BASF Corp. having an OH number of 115 mg KOH/g and a weight average molecular weight of 2000 g/mol. The resin is used in form of dispersion having a solid content of 80 wt.-%.

The emulsion microgel is a branched acrylic microgel emulsion available from BASF Corp. having an acid number of 10 mg KOH/g. The emulsion has a solid content of 31 wt.-%.

1.2 Solventborne Basecoat Composition BC2

Basecoat composition BC2 has been prepared by mixing the constituents listed in Table 1.2 in this order. BC2 contains an amino resin (Resimene® 747) as crosslinking agent, but does not contain any crosslinking catalyst. BC2 has a total solids content of 59.3 wt.-%, based on its total weight.

TABLE 1.2
Black basecoat BC2

| Constituent | Amount [wt.-%] |
|---|---|
| Emulsion microgel | 25.36 |
| N-Methylpyrrolidone | 0.82 |
| Butyl acetate | 1.83 |
| Pentyl propionate | 1.51 |
| Resimene ® 747 | 33.30 |
| Polybutylacrylate | 0.05 |
| Tinuvin ® 384-2 | 0.69 |
| Aerosil ® R-972 dispersion | 4.56 |
| Black pigment paste | 11.57 |
| (containing Monarch ® 1300) | |
| Cellulose acetate butyrate | 3.43 |
| (20 wt.-% solution) | |
| Filler paste (containing | 7.02 |
| barium sulfate) | |
| Blanc fixe micro paste | 5.77 |
| Pentyl propionate | 4.09 |
| Σ | 100.00 |

Resimene® 747 is hexamethoxymethyl melamine-formaldehyde resin (98 wt.-%). The emulsion microgel has already been described hereinbefore with respect to BC1.

1.3 Waterborne Basecoat Composition BC3

Basecoat composition BC3 has been prepared by mixing the constituents listed in Table 1.23 in this order. BC3 contains an amino resin (Resimene® 747) as crosslinking agent, but does not contain any crosslinking catalyst. BC3 has a total solids content of 52.0 wt.-%, based on its total weight.

TABLE 1.3
Black basecoat BC3

| Constituent | Amount [wt.-%] |
|---|---|
| Laponite ® solution (3.5 wt.-% | 16.17 |
| in deionized water) | |
| Deionized water | 13.61 |
| Ethylene glycol butyl ether | 4.26 |
| Resimene ® 747 | 18.70 |
| Black pigment paste 1 | 18.80 |
| Byk ® 345 | 0.20 |
| N,N-dimethylethanolamine | 0.08 |
| Viscalex ® HV30 | 8.16 |
| Dipropylene glycol propyl ether | 2.96 |
| Ethylene glycol butyl ether | 1.43 |
| Triisobutyl phosphate | 1.13 |
| Shell sol OMS | 0.84 |
| 2-Ethylhexanol | 2.41 |
| Pluracol ® 1010 | 0.56 |
| Tripropylene glycol methyl ether | 1.11 |
| N,N-dimethylethanolamine | 0.02 |
| N,N-dimethylethanolamine | 0.03 |
| Deionized water | 9.53 |
| Σ | 100.00 |

The black pigment paste 1 consists of 8.7 wt.-% black pigment, 9.7 wt.-% grind resin, 2.7 wt.-% organic solvent and 78.9 wt.-% water. The grind resin is an MPEG-stabilized polyurethane-acrylic resin with urea and aromatic anchor groups available from BASF Corp.

1.4 Solventborne basecoat composition BC4 (comparatively used)

Basecoat composition BC4 has been prepared by mixing the constituents listed in Table 1.4 in this order. BC4 contains two kinds of amino resins (Resimene® 755 and Resimene® 764) as crosslinking agents. Additionally, BC4 contains a crosslinking catalyst, namely a blocked sulfonic acid catalyst (an amine-blocked dodecyl benzene sulfonic acid (DDBSA).

TABLE 1.4
Black basecoat BC4

| Constituent | Amount [wt.-%] |
|---|---|
| Emulsion microgel | 22.66 |
| Aminomethyl propanol (AMP-95) | 0.26 |
| N-Methylpyrrolidone | 0.73 |
| Butyl acetate | 1.63 |
| Pentyl propionate | 1.35 |
| Polyester resin (star-shaped) | 6.16 |
| Resimene ® 755 | 6.13 |
| Resimene ® 764 | 6.13 |
| Polybutylacrylate | 0.04 |
| Tinuvin ® 384-2 | 0.61 |
| Filler paste (containing barium sulfate) | 6.30 |
| Blanc fixe micro paste | 5.15 |
| Aerosil ® R-972 dispersion | 4.08 |
| Black pigment paste (containing | 10.45 |
| Monarch ® 1300) | |
| Acrylic resin 1 | 14.82 |
| Cellulose acetate butyrate | 3.07 |
| (20 wt.-% solution) | |
| Diisopropanolamine-blocked DDBSA in | 2.10 |
| Isopropanol (37% solids) | |
| Pentyl propionate | 8.30 |
| Σ | 100.00 |

Emulsion microgel, acrylic resin 1, and polyester resin (star-shaped) have already been described with respect to BC1.

2. Clearcoats Used as Second Coating Material Composition

2.1 Solventborne Clearcoat Composition CCI

Clearcoat composition CC1 has been prepared by mixing the constituents listed in Table 2.1 in this order. CC1 contains an amino resin (Resimene® 747) as crosslinking agent. CC1 has a total solids content of 57.9 wt.-%, based on its total weight.

TABLE 2.1
Clearcoat CC1

| Constituent | Amount [wt.-%] |
|---|---|
| Tinuvin ® 928 (30 wt.-% solution) | 4.37 |
| Carbamate acrylic resin | 28.32 |
| Resimene ® 747 | 17.23 |
| n-Butanol | 3.22 |
| Resin blend (50 wt.-% C₃₆ dicarbamate/ | 10.00 |
| 50 wt.-% IPDI/HPC reactive intermediate) | |
| IPDI/HPC reactive intermediate | 6.82 |
| Ethyl 3-ethoxy propionate | 1.48 |
| Thermoset acrylic resin | 5.07 |
| Aerosil ® R-974 dispersion | 15.55 |
| BYK ® LP R 23429 | 0.21 |
| Polybutylacrylate | 0.15 |
| FLOWLEN ® AC-300 | 0.03 |
| N-Methylpyrrolidone | 0.97 |
| Acrylic resin 2 | 1.80 |
| Tinuvin ® 123 | 0.54 |
| Dibutyltin diacetate | 0.20 |
| Naxcat ® 1270 | 0.38 |
| Propylene glycol monomethyl ether | 1.83 |
| n-Butyl acetate | 1.83 |
| Σ | 100.00 |

The carbamate acrylic resin is available from BASF Corp. has an OH number of 0 mg KOH/g and a weight average molecular weight of 4000 g/mol. The carbamate equivalent weight is 438 g/mol. The resin is used in form of dispersion having a solid content of 70 wt.-%.

The C36 dicarbamate present in the resin blend, which is obtainable from 2 mmol methyl carbamate and 1 mmol of a C36 diol, is used in form of a dispersion having a solid content of wt.-%. The carbamate equivalent weight is 344 g/mol. The IPDI/HPC reactive intermediate present in the resin blend, which is obtainable from 1 mol IPDI trimer and 3 mol of hydroxypropyl carbamate, is used in form of a dispersion having a solid content of 38.5 wt.-%. The carbamate equivalent weight is 374 g/mol. The resin blend used has in total a solid content of 55 wt.-%.

The IPDI/HPC reactive intermediate present in CC1 as such has already been described with respect to the resin blend.

Acrylic resin 2 is available from BASF Corp. and is an GMA-acrylic resin, i.e. an epoxy resin having a weight average molecular weight of 27400 g/mol. The epoxy equivalent weight is 430 g/mol. The resin is used in form of dispersion having a solid content of 60 wt.-%.

Thermoset acrylic resin is available from BASF Corp. and is OH-functional-acrylic resin having an OH number of 182 mg KOH/g and a weight average molecular weight of 4600 g/mol. The resin is used in form of dispersion having a solid content of 67.5 wt.-%.

BYK® LP R 23429 is commercially available rheology additive from BYK Chemie GmbH.

2.2 Solventborne Clearcoat Composition CC2

Clearcoat composition CC2 has been prepared by mixing the constituents listed in Table 2.2 in this order. CC2 does not contain any crosslinking agent, in particular no amino resin. CC2 has a total solids content of 55.0 wt.-%, based on its total weight.

TABLE 2.2
Clearcoat CC2

| Constituent | Amount [wt.-%] |
|---|---|
| Tinuvin ® 928 (30 wt.-% solution) | 3.97 |
| Carbamate acrylic resin | 19.77 |
| Polycin ® M-365 | 12.33 |
| n-Butanol | 2.92 |
| Resin blend (50 wt.-% C₃₆ dicarbamate/ | 9.08 |
| 50 wt.-% IPDI/HPC reactive intermediate) | |
| IPDI/HPC reactive intermediate | 6.19 |
| Ethyl 3-ethoxy propionate | 1.34 |
| Thermoset acrylic resin | 4.60 |
| Aerosil ® R-974 dispersion | 14.12 |
| BYK ® LP R 23429 | 0.20 |
| Polybutylacrylate | 0.14 |
| FLOWLEN ® AC-300 | 0.02 |
| Exxal ® 13 | 1.00 |
| N-Methylpyrrolidone | 0.88 |
| Tinuvin ® 123 | 0.50 |
| Naxcat ® 1270 | 3.49 |
| Setalux ® 10-9701 | 14.09 |
| Propylene glycol monomethyl ether | 1.66 |
| n-Butyl acetate | 3.71 |
| Σ | 100.00 |

Setalux® 10-9701 is commercially available.

Polycin® M-365 is a castor oil based polyol having an OH number of 365 mg KOH/g (100 wt.-solids).

Carbamate acrylic resin, resin blend (50 wt.-% C36 dicarbamate/50 wt.-% IPDI/HPC reactive intermediate), IPDI/HPC reactive intermediate and the thermoset acrylic resin have already been described with respect to CC1.

2.3 Solventborne Clearcoat Composition CC3 (Comparatively Used)

Clearcoat composition CC3 has been prepared by mixing the constituents listed in Table 2.3 in this order. CC3 contains an amino resin (Resimene® 747) as crosslinking agent.

Additionally, CC3 contains two kinds of crosslinking catalysts, namely a blocked sulfonic acid catalyst (an amine-blocked dodecyl benzene sulfonic acid (DDBSA) as well as Naxcat® 1270.

TABLE 2.3
Clearcoat CC3

| Constituent | Amount [wt.-%] |
|---|---|
| Tinuvin ® 928 (30 wt.-% solution) | 4.06 |
| Carbamate acrylic resin | 20.24 |
| Resimene ® 747 | 9.60 |
| Desmodur PL350 MPA/SN | 2.69 |
| n-Butanol | 2.99 |
| Resin blend (50 wt.-% C36 dicarbamate/ | 9.29 |
| 50 wt.-% IPDI/HPC reactive intermediate) | |
| IPDI/HPC reactive intermediate | 6.34 |
| Thermoset acrylic resin | 4.71 |
| Aerosil ® R-974 dispersion | 14.45 |
| Exxal ® 13 | 1.02 |
| Ethyl 3-ethoxy propionate | 1.25 |
| BYK ® LP R 23429 | 0.20 |
| Polybutylacrylate | 0.14 |
| FLOWLEN ® AC-300 | 0.02 |
| Acrylic resin 2 | 1.67 |
| Tinuvin 123 9 | 0.51 |
| Dibutyltin diacetate | 0.19 |
| Octanoic acid | 0.25 |
| Nacure ® XC-6206 (34% solids 3,5- | 2.20 |
| dimethyloxazolidine-blocked DDBSA in isobutanol) | |
| Naxcat ® 1270 | 0.36 |
| Setalux ® 10-9701 | 14.42 |
| Propylene glycol monomethyl ether | 1.70 |
| Primary Amyl Acetate | 1.70 |
| Σ | 100.00 |

Carbamate acrylic resin, resin blend (50 wt.-% C36 dicarbamate/50 wt.-% IPDI/HPC reactive intermediate), IPDI/HPC reactive intermediate, acrylic resin 2 and the thermoset acrylic resin have already been described with respect to CC1.

3. Preparation of Multilayer Coating Systems

3.1 Multilayer Coating System IE1 Obtained by Making Use of Basecoat Composition BC1 and Clearcoat Composition CC1

Cold rolled steel test panels measuring 4″×12″ were used as a substrate. The panels were pretreated with Bondrite® 958 zinc phosphate pretreatment and rinsed with Parcolene® 90 post-rinse, both available from Henkel. The panels were electrocoated with a 0.7-0.8 mil layer of BASF Cathoguard® 800 electrocoat and baked for 20 minutes at 350° F. (176.7° C.) substrate temperature. The panels were sprayed with a 0.9-1.1 mil layer of BASF U28AW110 gray solventborne primer and baked for 25 minutes at 265° F. (129.4° C.). BC1 was sprayed onto the primed panels and flashed under ambient conditions for four minutes. Then CC1 was applied and allowed to flash under ambient conditions for ten minutes. After the CC flash the panels were baked for 20 minutes at 210° F. (98.9° C.).

Prior to applying BC1 to the substrate, it was diluted with n-butyl acetate to 40 cP resulting in a solids content of 50.49 wt.-%. Prior to applying CC1 to the substrate, it was diluted with n-butyl acetate to 105 cP.

The dry film thickness of basecoat BC1 after curing was 0.6 mils (15.24 nm) and the dry film thickness of clearcoat CC1 after curing was 1.8 mils (45.72 nm).

3.2 Multilayer Coating System 1E2 Obtained by Making Use of Basecoat Composition BC2 and Clearcoat Composition CC2

Cold rolled steel test panels measuring 4″×12″ were used as a substrate. The panels were pretreated with Bondrite0 958 zinc phosphate pretreatment and rinsed with Parcolene® 90 post-rinse, both available from Henkel. The panels were electrocoated with a 0.7-0.8 mil layer of BASF Cathoguard® 800 electrocoat and baked for 20 minutes at 350° F. (176.7° C.) substrate temperature. The panels were sprayed with a 0.9-1.1 mil layer of BASF U28AW110 gray solventborne primer and baked for 25 minutes at 265° F. (129.4° C.). BC2 was sprayed onto the primed panels and flashed under ambient conditions for four minutes. Then CC2 was applied and allowed to flash under ambient conditions for ten minutes. After the CC flash the panels were baked for 20 minutes at 210° F. (98.9° C.).

Prior to applying BC2 to the substrate, it was diluted with n-butyl acetate to 40 cP. Prior to applying CC2 to the substrate, it was diluted with n-butyl acetate to 85 cP.

The dry film thickness of basecoat BC2 after curing was 0.6 mils (15.24 μm) and the dry film thickness of clearcoat CC2 after curing was 1.8 mils (45.72 μm).

3.3 Multilayer coating system 1E3 obtained by making use of basecoat composition BC3 and clearcoat composition CC2

Cold rolled steel test panels measuring 4″×12″ were used as a substrate. The panels were pretreated with Bondrite® 958 zinc phosphate pretreatment and rinsed with Parcolene® 90 post-rinse, both available from Henkel. The panels were electrocoated with a 0.7-0.8 mil layer of BASF Cathoguard® 800 electrocoat and baked for 20 minutes at 350° F. (176.7° C.) substrate temperature. The panels were sprayed with a 0.9-1.1 mil layer of BASF U28AW110 gray solventborne primer and baked for 25 minutes at 265° F. (129.4° C.). BC3 was sprayed onto the primed panels and flashed for five minutes at 140° F. (60.0° C.). Then CC2 was applied and allowed to flash under ambient conditions for ten minutes. After the CC flash the panels were baked for 20 minutes at 210° F. (98.9° C.).

Prior to applying BC3 to the substrate, it was diluted to 80 cP. Prior to applying CC2 to the substrate, it was diluted with n-butyl acetate to 85 cP.

The dry film thickness of basecoat BC3 after curing was 0.6 mils (15.24 μm) and the dry film thickness of clearcoat CC2 after curing was 1.8 mils (45.72 μm).

3.4 Multilayer Coating System 1E4 Obtained by Making Use of Basecoat Composition BC4 and Clearcoat Composition CC3 (comparative)

Cold rolled steel test panels measuring 4″×12″ were used as a substrate. The panels were pretreated with Bondrite® 958 zinc phosphate pretreatment and rinsed with Parcolene® 90 post-rinse, both available from Henkel. The panels were electrocoated with a 0.7-0.8 mil layer of BASF Cathoguard® 800 electrocoat and baked for 20 minutes at 350° F. (176.7° C.) substrate temperature. The panels were sprayed with a 0.9-1.1 mil layer of BASF U28AW110 gray solventborne primer and baked for 25 minutes at 265° F. (129.4° C.). BC4 was sprayed onto the primed panels and flashed for five minutes at 140° F. (60.0° C.). Then CC3 was applied and allowed to flash under ambient conditions for ten minutes. After the CC flash the panels were baked for 20 minutes at 210° F. (98.9° C.).

4. Properties of the Substrates Coated with the Multilayer Coating Systems

4.1 Multilayer Coating System IE1

In Table 4.1 a number of properties measured and/or determined according to the methods defined in the “Methods” section are summarized.

TABLE 4.1
Properties of IE1

| | |
|---|---|
| Tukon hardness (target >7) | ok |
| 100 MEK double rubs | ok |
| Freezer gravel (3 pints) | ok |
| Initial adhesion | 5 B |
| Adhesion after 10-day water soak | 5 B |
| Appearance after 10-day water soak | ok |
| MVSS (initial pull) | ok |
| MVSS (after 10-day water soak) | ok |

4.2 Multilayer Coating System IE2

In Table 4.2 a number of properties measured and/or determined according to the methods defined in the “Methods” section are summarized.

TABLE 4.2
Properties of IE2

| | |
|---|---|
| Tukon hardness (target >7) | ok |
| Initial adhesion | 5 B |
| Adhesion after 10-day water soak | 5 B |
| MVSS (initial pull) | ok |
| MVSS (after 10-day water soak) | ok |

4.3 Multilayer Coating System IE3

In Table 4.3 a number of properties measured and/or determined according to the methods defined in the “Methods” section are summarized.

TABLE 4.3
Properties of IE3

| | |
|---|---|
| Tukon hardness (target >7) | ok |
| Initial adhesion | 5 B |
| Adhesion after 10-day water soak | 5 B |
| MVSS (initial pull) | ok |

4.4 Multilayer Coating System IE4

After the preparation and after baking as described in item 3.4 for 20 minutes at 210° F. (98.9° C.) as in case of IE1, IE2 and IE3, the multilayer coating system IE4 present on the panels obtained was noted to be tacky (not cured) and unsuitable for testing according to the same protocols that have been successfully performed for IE1, IE2 and IE3: in contrast to IE4 each of IE1, IE2 and IE3 exhibited an excellent cure (no tackiness) when baked for 20 minutes at 210° F. (98.9° C.). A sufficient cure in case of IE4 could only be achieved after 20 minutes at 285° F. (140° C.), i.e. at a significantly higher baking temperature.

1. A method for preparing a multilayer coating system on a substrate comprising:
(1) applying a first coating material composition to an optionally pre-coated substrate and forming a first coating film on the optionally pre-coated substrate,
(2) applying a second coating material composition to the first coating film present on the substrate obtained after step (1) prior to curing the first coating film and forming a second coating film adjacent to the first coating film,
(3) jointly curing the first and second coating films, the cured second coating film being the outermost layer of the formed multilayer coating system,
wherein the first and second coating material compositions are different from one another, the first coating material composition comprises at least one polymer (P1) having crosslinkable functional groups and the second coating material composition comprises at least one polymer (P2) having crosslinkable functional groups, and
wherein one of the first and second coating material composition further comprises prior to its use in step (1) or (2) at least one amino resin (AR) as crosslinking agent having crosslinkable functional groups, which can be crosslinked with the crosslinkable functional groups of both polymer (P1) and polymer (P2), and the remaining of these two coating material compositions prior to its use in step (1) or (2) is free of any crosslinking agents, but comprises prior to its use in step (1) or (2) at least one crosslinking catalyst (CLC1), which is suitable to catalyze a crosslinking reaction between the functional groups of the amino resin (AR) and the functional groups of both polymer (P1) and polymer (P2).

2. The method according to claim 1, characterized in that it comprises a further step (1a) and/or a further step (2a), step (1a) being carried out after step (1) and before step (2), and step (2a) being carried out after step (2) and before step (3),
(1a) flashing-off the first coating film obtained after step (1) before applying the second coating material composition in step (2) for a period of 1 to 20 minutes, and/or
(2a) flashing-off the second coating film obtained after step (2) before performing curing step (3) for a period of 1 to 20 minutes.

3. The method according to claim 1, characterized in that the coating material composition selected from the group consisting of the first and second coating material compositions, which comprises prior to its use in step (1) or (2) the at least one amino resin (AR) as crosslinking agent, does not comprise prior to its use in step (1) or (2) any crosslinking catalyst at all or comprises prior to its use in step (1) or (2) at least one crosslinking catalyst (CLC2) being identical or different to the at least one crosslinking catalyst (CLC1) in an amount, based on the total weight of the coating material composition, which is lower than the amount of the least one crosslinking catalyst (CLC1) present in the remaining of the said two coating material compositions, which is prior to its use in step (1) or (2) free of any crosslinking agents, based on the total weight of said coating material composition.

4. The method according to claim 1, characterized in that the first coating material composition comprises prior to its use in step (1) the at least one amino resin (AR) as crosslinking agent and optionally at least one crosslinking catalyst (CLC2) being identical or different to the at least one crosslinking catalyst (CLC1) and the second coating material composition comprises prior to its use in step (2) the at least one crosslinking catalyst (CLC1) or in that the second coating material composition comprises prior to its use in step (2) the at least one amino resin (AR) as crosslinking agent and optionally at least one crosslinking catalyst (CLC2) being identical or different to the at least one crosslinking catalyst (CLC1) and the first coating material composition comprises prior to its use in step (1) the at least one crosslinking catalyst (CLC1).

5. The method according to claim 1, characterized in that the first coating material composition is a solventborne or waterborne coating material composition and the second coating material composition is a solventborne coating material composition.

6. The method according to any-of-the-preeeding-elitim* claim 1, characterized in that the first coating material composition is a basecoat material coating composition and the second coating material composition is a clearcoat coating material composition or the first coating material composition is a primer material coating composition and the second coating material composition is a topcoat coating material composition.

7. The method according to claim 1, characterized in that step (3) is performed at a temperature less than 110° C., for a period of 5 to 45 minutes.

8. The method according to claim 1, characterized in that the at least one amino resin (AR) used as crosslinking agent present is an aminoplast resin.

9. The method according to claim 1, characterized in that the at least one amino resin (AR) used as crosslinking agent has a maximum number average molecular weight of 1500 g/mol.

10. The method according to claim 1, characterized in that the at least one amino resin (AR) is present in the one of the first and second coating material composition in an amount in a range of from 10 to 40 wt.-%, based on the total weight of the coating material composition.

11. The method according to claim 1, characterized in that the at least one crosslinking catalyst (CLC1) is an unblocked sulfonic acid.

12. The method according to claim 1, characterized in that the at least one crosslinking catalyst (CLC1) is present in the one of the first and second coating material composition in an amount in the range of from 5 to wt.-%, based on the total solids content of the coating material composition.

13. The method according to claim 1, characterized in that each of the polymers (P1) and (P2) has hydroxyl groups as crosslinkable functional groups.

14. (canceled)

15. A method of using amino resin (AR) having crosslinkable functional groups, the method comprising using amino resin
which is present in either a first coating material composition or a second coating material composition, both coating material compositions being different from one another, the first coating material composition comprising at least one polymer (P1) having crosslinkable functional groups, which can be crosslinked with the crosslinkable functional groups of the amino resin (AR), and the second coating material composition comprising at least one polymer (P2) having crosslinkable functional groups, which can be also crosslinked with the crosslinkable functional groups of the amino resin (AR), wherein the coating material composition selected from the group consisting of the first and second coating material composition, in which the amino resin (AR) is not present, is free of any crosslinking agents, but comprises at least one crosslinking catalyst (CLC1), which is suitable to catalyze a crosslinking reaction between the functional groups of the amino resin (AR) and the functional groups of both polymer (P1) and polymer (P2),
for at least partially migrating from a coating film obtained from the one coating material composition selected from the group consisting of the first and second coating material composition, in which it is present, into a coating film obtained from the remaining coating material composition of these two coating material compositions after having applied the second coating material composition to a coating film obtained from the first coating material composition prior to curing said first coating film to form a second coating film adjacent to the first coating film
and for subsequent crosslinking with the crosslinkable functional groups of both polymer (P1) and polymer (P2).

16. The method according to claim 1, characterized in that step (3) is performed at a temperature less than 105° C. for a period of 10 to 35 minutes.

17. The method according to claim 1, characterized in that the at least one amino resin (AR) used as crosslinking agent is a melamine resin.

18. The method according to claim 1, characterized in that the at least one amino resin (AR) used as crosslinking agent is a melamine formaldehyde resin.

19. The method according to claim 1, characterized in that the at least one amino resin (AR) used as crosslinking agent present is a hexamethoxymethyl melamine formaldehyde resin.

20. The method according to claim 1, characterized in that the at least one amino resin (AR) used as crosslinking agent has a maximum number average molecular in the range of 200 to 1500 g/mol.

21. The method according to claim 1, characterized in that the at least one amino resin (AR) used as crosslinking agent has a maximum number average molecular in the range of 250 to 1000 g/mol.
